(19) United States
(12) Patent Application Publication
(10) Pub. No.: US 2015/0271026 A1
(43) Pub. Date: Sep. 24, 2015

(54) END USER PERFORMANCE ANALYSIS

(71) Applicant: Microsoft Technology Licensing, LLC, Redmond, WA (US)

(72) Inventors: Venkata Kiran Kumar Meduri, Redmond, WA (US); Pravjit Tiwana, Bellevue, WA (US)

(21) Appl. No.: 14/223,931

(22) Filed: Mar. 24, 2014

(51) Int. Cl. H04L 12/24; H04L 29/08; H04L 12/26

(52) U.S. Cl. CPC H04L 41/147; H04L 43/0888; H04L 67/1095; H04L 67/18; H04L 67/303

(57) ABSTRACT

A performance monitoring system collects profile data relative to an already-existing user, or a potential user. A predictive analysis is performed to predict whether the current performance, or predicted performance, meets an expected performance level. Key performance indicators are output and are indicative of the comparison.

### BACKGROUND

Computer systems are currently in wide use. Many such computer systems are offered as services in a network-based, or cloud-based computing environment.

When a customer is contemplating purchasing such a service, the customer can experience apprehension about the expected latency and performance of the service. Some services today can provide information into expectations as to the uptime and availability of the service. However, these are not the only factors that influence the performance of a service in a given user environment. For instance, even if the service has a high degree of uptime and availability, it may be that the customer's particular environment hinders the performance of the service.

In a scenario where a customer has already purchased a service, it may be that the customer still has questions about the performance of the service. For instance, if the customer is having an unsatisfactory experience with the service, it may be that the customer is unable to troubleshoot his or her own system to enhance his or her experience with the service. Similarly, the customer is unable to determine whether he or she may be experiencing the same performance as other customers in the same geographic region, with the same setup.

The manufacturers and sellers of the service can also have issues related to its performance. For instance, it is common for a manufacturer or seller to undergo a process by which they attempt to determine whether it is worth launching a product in a given geographic location (such as a given country, region or other location). The cost of launching a service in a geographic region can be fairly significant, especially if there is a large amount of translation or localization to be performed prior to launching the service.

The discussion above is merely provided for general background information and is not intended to be used as an aid in determining the scope of the claimed subject matter.

### SUMMARY

A performance monitoring system collects profile data relative to an already-existing user, or a potential user. A predictive analysis is performed to predict whether the current performance, or predicted performance, meets an expected performance level. Key performance indicators are output and are indicative of the comparison.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a performance analysis architecture.

FIG. 2 is a block diagram of one embodiment of a performance monitoring and prediction system.

FIG. 3 is a flow diagram illustrating one embodiment of the operation of the system shown in FIG. 1.

FIGS. 3A-3E2 are exemplary user interface displays.

FIGS. 4-8 show various embodiments of mobile devices.

FIG. 9 shows a block diagram of one embodiment of a computing environment.

### DETAILED DESCRIPTION

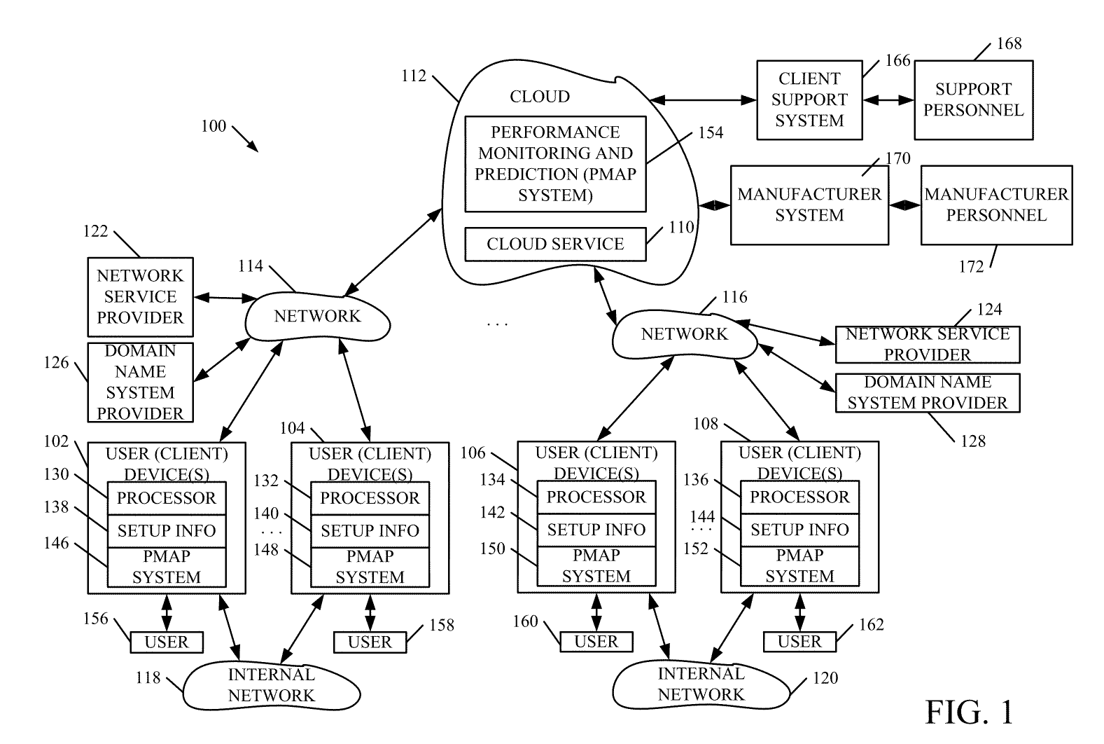

FIG. 1 shows one embodiment of an end user performance analysis architecture 100. Architecture 100 is shown with a plurality of end user devices 102, 104, 106 and 108 having access to a cloud service 110, that is deployed in cloud 112. Access is shown as being provided over networks 114 and 116. It will be noted that networks 114 and 116 can be the same or different networks, as described in greater detail below.

The end users 102-108 can be coupled to one another using an external network (such as networks 114 or 116) or an internal network (such as networks 118 and 120). User devices 102-108 are illustratively provided with access to cloud service 110 by network service providers 122 and 124, which can be Internet service providers, or other network service providers. In one embodiment, the user devices also use a domain name system (DNS) provider 126-128.

Each user device 102-108 illustratively includes a processor 130, 132, 134 or 136, respectively. They also each illustratively include hardware configuration and network setup information 138, 140, 142 and 144, respectively. Further, each can include a performance monitoring and prediction (PMAP) system 146, 148, 150 or 152, respectively. Alternatively, the PMAP system can be located in cloud 112 (as indicated by number 154) or elsewhere. In another embodiment, components of the PMAP system can be disposed in the cloud 112, while other components are disposed on the particular user device. All of these architectures are contemplated herein.

In the example embodiment shown in FIG. 1, users 156, 158, 160 and 162 use user devices 102-108, respectively, in order to access service 110, through corresponding networks 114 or 116. In doing so, service 110 can have a client-side component or the entire service can be performed within cloud 112. In either case, cloud service 110 illustratively includes a user interface component that provides user interface displays for users 156-162. The user interface displays can have user input mechanisms that are manipulated by the corresponding users in order to control and manipulate cloud service 110.

In one embodiment, cloud service 110 is a multi-tenant service in which servers and databases are provided to service multiple different tenants. The tenants can each correspond to a separate organization. Therefore, they can each have their own separate and partitioned processes and data, corresponding to their given implementation of cloud service 110. In another embodiment, service 110 is a multi-instance service in which each client has an instance of service 100 to serve them.

Architecture 100 also illustratively shows that a client support system 166 has access to cloud service 110 so that client support personnel 168 can provide support services for users 158-162, as they use cloud service 110. Further, manufacturer system 170 provides manufacturer personnel 172 (that manufacture and sell cloud services 110) access to cloud service 110 as well.

Performance monitoring and prediction (PMAP) systems 146-154 can be used in a plurality of different scenarios. For instance, when a given user (such as user 156) is contemplating signing up for or otherwise purchasing access to cloud service 110, the user may be wondering about the performance that the user will experience, given the user's particular configuration (such as the user's network service provider 122, DNS provider 126, and the user's internal network 118 and hardware and software setup information 138). In such a scenario, the user can use either a client-based PMAP system 146 or a cloud-based PMAP system 154. The user can run the particular PMAP system, which will identify a wide variety of different types of information that can affect the performance of cloud service 110, for the given user 156. The PMAP system can then generate a prediction, based on the performance experienced by other similar users, indicative of the predicted performance for user 156, given all the information that has been gathered and based on a predictive analysis that is performed.

In a second scenario, it may be that manufacturer personnel 172 are attempting to determine whether it is worth localizing or otherwise translating cloud service 110 so that it can be launched in a given geographic area. In that case, manufacturer personnel 172 can access PMAP system 154 in order to gather information from a hypothetical user in that particular geographic location. PMAP system 154 can then provide a prediction as to the expected performance of cloud service 110, in the given geographic location, based upon the information gathered, and again based upon a predictive analysis performed, given that information.

In another scenario, it may be that a user (such as user 156) is already a customer and is using cloud service 110. It may also be that user 156 is perceiving that the performance of cloud service 110 is somehow deficient. In that case, user 156 can use PMAP system 146 or PMAP system 154 to gather information and provide a prediction as to the performance that user 156 should be expecting from cloud service 110, given the user's particular configuration and given the experience of other users in a similar geographic location. The predicted performance can also be compared against the actual performance of cloud service 110 for user 156. This comparison can be used to determine whether the actual performance experienced by the user is within a given threshold of the expected performance. If not, the PMAP system that is being used by user 156 can also identify problem areas and assist user 156 in troubleshooting the problems, in order to increase the performance of cloud service 110, for user 156.

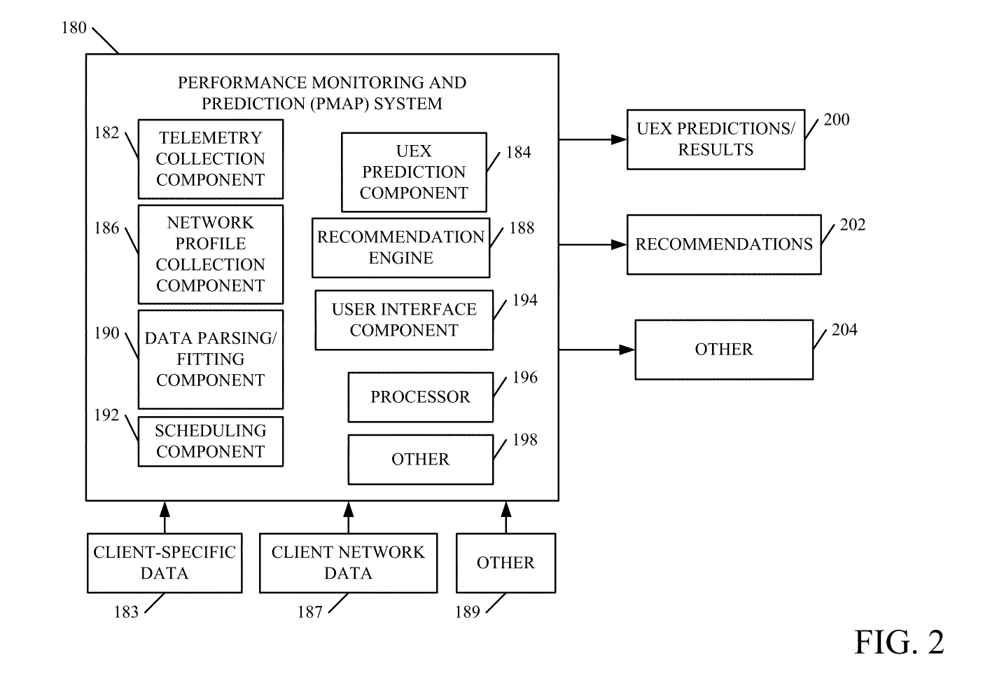

Before describing the overall operation of architecture 100 in more detail, a description will be provided of a more detailed embodiment of one example of a given PMAP system. FIG. 2 shows a more detailed block diagram of PMAP system 180. It will be noted that PMAP system 180 can be any of the PMAP systems shown in FIG. 1, or a separate PMAP system. In the embodiment shown in FIG. 2, PMAP system 180 can include telemetry collection component 182, user experience prediction component 184, network profile collection component 186, recommendation engine 188, data parsing/fitting component 190, scheduling component 192, user interface component 194, processor 196, and it can include other items 198 as well. Telemetry collection component 182 can collect client-specific data 183. Data 183 can be a variety of configuration and other information from a given user device or from the environment of the user device. Examples of the types of information collected are described in greater detail below.

Network profile collection information 186 can collect network data 187. Data 187 can be a variety of different types of network profile information. For instance, it can be network service provider information from the network service provider 122 for a given user, DNS provider information from the DNS provider 126, internal network information from an internal network 118, network setup information 138 from a given user device and a host of other information.

Components of system 180 can collect other information as well. This is indicated by block 189.

Scheduling component 192 allows a user or administrator to schedule a performance monitoring run of PMAP system 180 for the given user. Also, a schedule for repeated runs can be set as well.

Data parsing/fitting component 190 parses all of the information collected for a given user and can perform different operations to provide information to UEX prediction component 184. UEX prediction component 184 can provide an output indicative of the predicted performance for cloud service 110, for the given user. For instance, data parsing/fitting component 190 can parse the data and fit it to sample data from other users of cloud system 110 and provide that information to UEX prediction component 184. Based upon that information, UEX prediction component 184 can predict what the user's performance should be, given the sample data collected from other users with similar network configurations, in similar geographic locations, with similar hardware configurations, etc. Component 184 can provide the UEX prediction results 200 so that the user, or a variety of other persons, can review the prediction information. Some examples of predictions are described below.

To the extent that the user's expected performance does not meet the user's actual performance, recommendation engine 188 can be invoked to provide recommendations 202. Recommendations 202 can identify trouble spots in the user's configuration, including the user's network service provider 122, DNS provider 126, internal network 118, and a host of other potential trouble spots. Recommendations 202 can also assist the user in attempting to troubleshoot those trouble spots to increase performance. PMAP system 180 can provide other outputs 204 as well.

User interface component 194 can be used by various items of PMAP system 180, or under its own control, to provide the predictions or results 200. Results 200 can be provided along with the recommendations 202 and other outputs 204, for use by the user or other persons.

While a number of exemplary components in PMAP system 180 have been described, a wide variety of others can be used. For example, the various data collection and analysis components in PMAP system 180 can include an extensible diagnostic service which includes real time and scalable components that perform data collection from any log type counters on each node of the monitored systems. It can also include an extensible real user monitoring pipeline to measure and monitor end user experience in terms of page loads and other network performance criteria. It can include a client's performance analyzer that is an extensible automated tool that is used to collect all possible last mile performance and network diagnostics. It can be run from a customer location and provide information indicative of the cause of latencies (if any). The prediction component 184 can use a variety of predictive mechanisms. For instance, it can use a data warehouse for synthetic test runs around the globe to measure the end user performance. It can also parse logs and perform transforms and trigger alerts, as well. These are exemplary only.

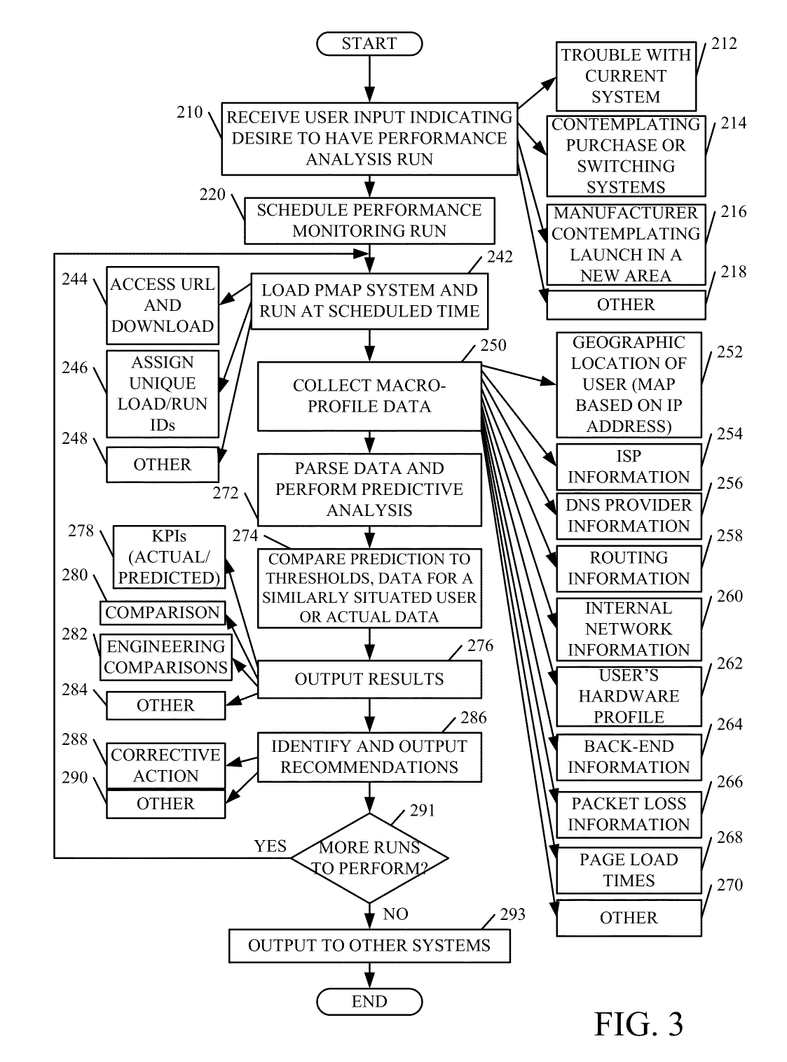

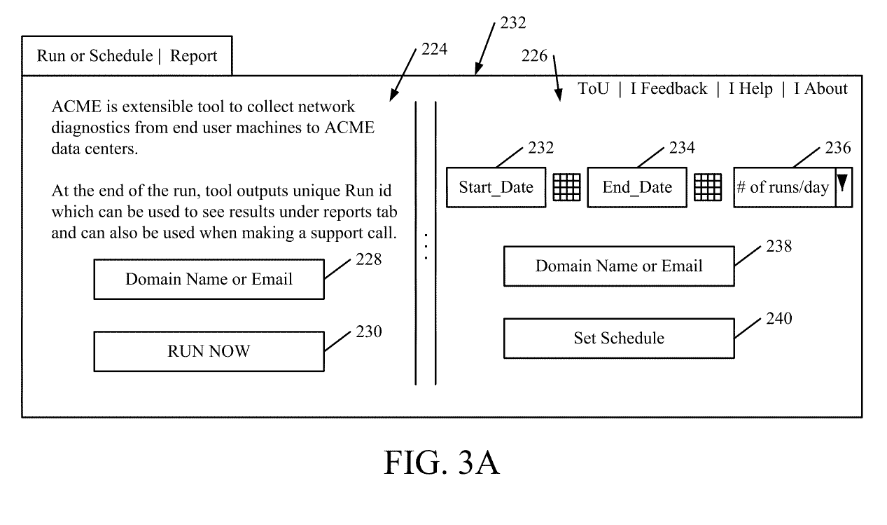

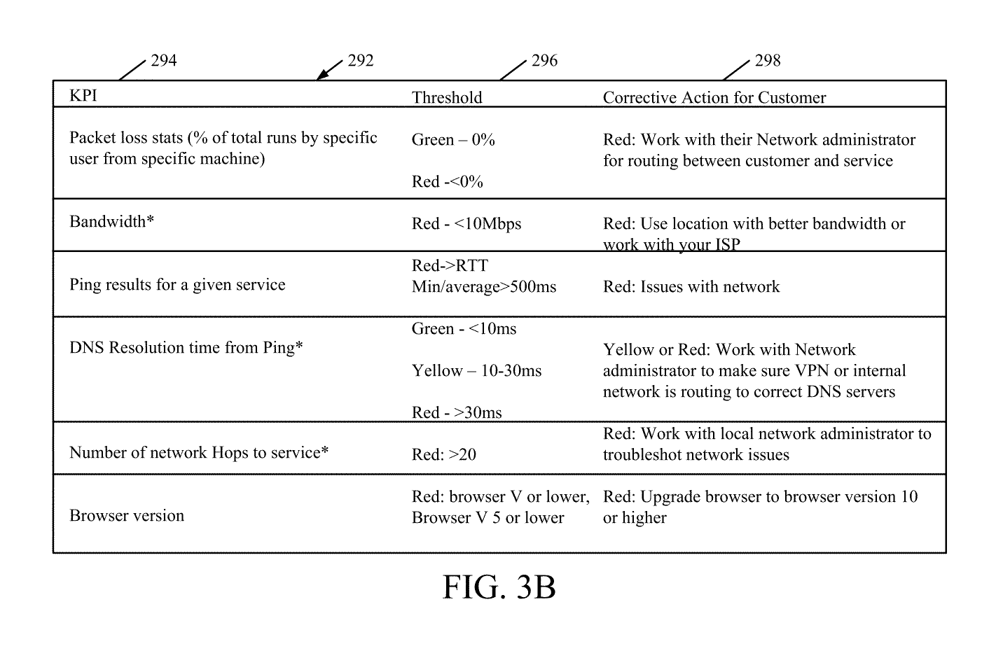

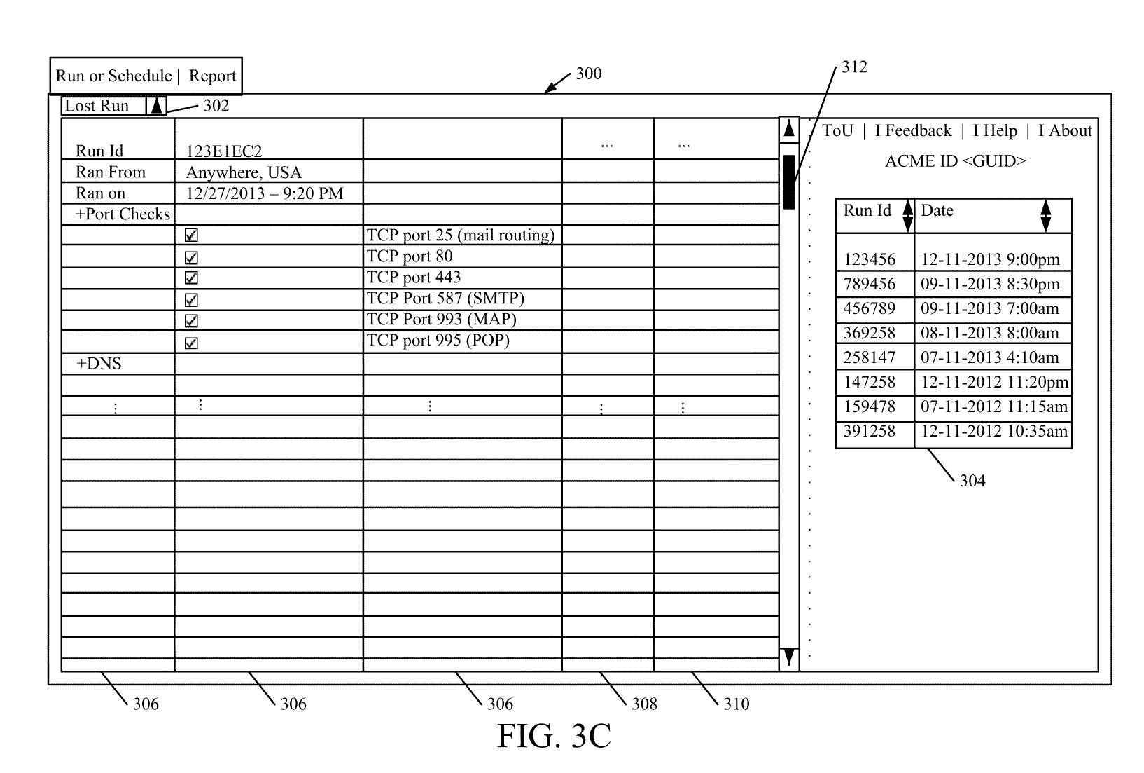

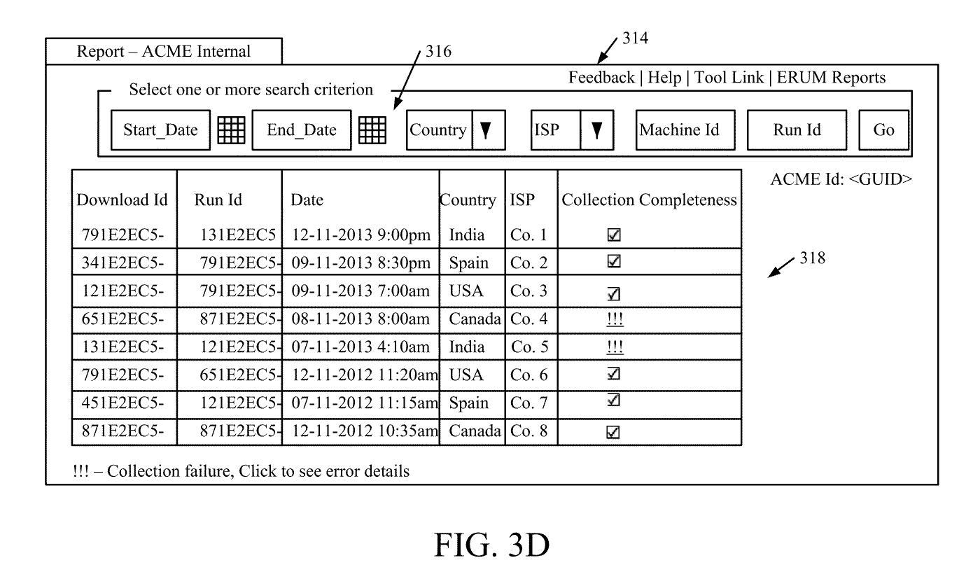

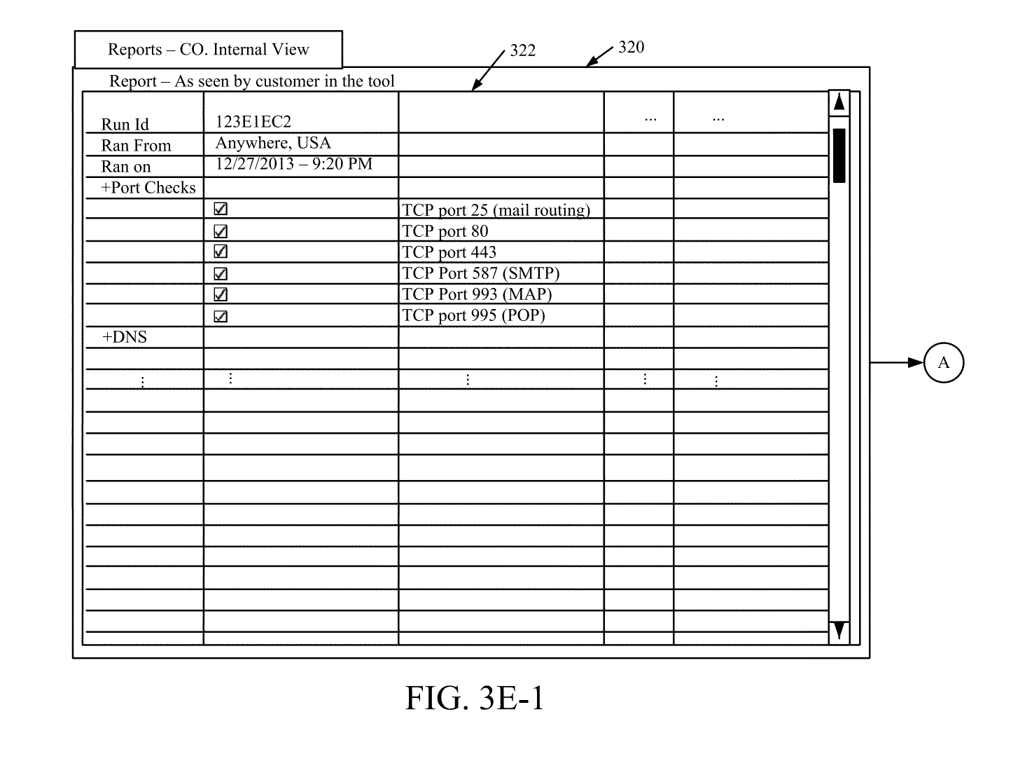

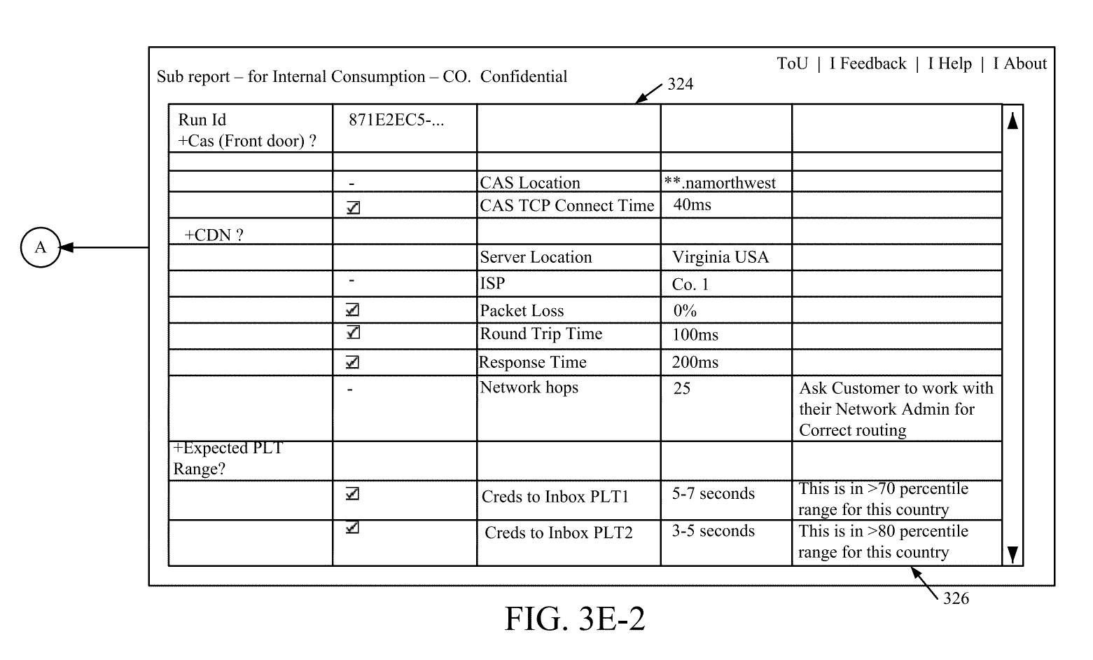

FIG. 3 is a flow diagram illustrating one embodiment of the overall operation of PMAP system 180 in assisting various persons (such as manufacturer personnel 172, any of users 156-162, support personnel 168) shown in the architecture of FIG. 1. In describing FIG. 3, it will be assumed that PMAP system 180 can be any of the PMAP systems shown in FIG. 1.

PMAP system 180 first receives a user input indicating a desire to have performance analysis take place with respect to a given user or set of users. This is indicated by block 210 in FIG. 3. For instance, as discussed above, it may be that user 156 is already a customer using cloud service 110, but user 156 perceives that he or she is experiencing an undesirably low level of performance of service 110. This is indicated by block 212. In another scenario, it may be that user 156 is contemplating purchasing access to cloud service 110, or switching from an on-premise version of service 110 to a cloud-based service 110, or is otherwise contemplating switching to service 110. This is indicated by block 214. In yet another scenario, it may be that manufacturer personnel 172 are contemplating launching service 110 in a new area. This is indicated by block 216. In any case, the user inputs indicating a desire to have performance analysis performed can be these or other inputs 218 as well.

In one embodiment, scheduling component 192 then provides one or more user interface displays with user input mechanisms that allow the user to schedule a performance and monitoring run of PMAP system 180. Providing those displays and scheduling the run is indicated by block 220 in FIG. 3.

FIG. 3A shows one illustrative user interface display 222 that allows the user to schedule a run. The user interface display 222 illustratively includes mechanisms that allow the user to either immediately run or schedule a later run of a performance monitoring and analysis operation. It can be seen that user interface display 222 includes an immediate run portion 224 and a scheduling portion 226. Immediate run portion 224 allows the user to input identifying information, such as the user's domain name or e-mail address, using user input mechanism 228. The user can then immediately run the performance monitoring and analysis operation by actuating user input mechanism 230.

On scheduling portion 226, the user can schedule the start and end dates for running the performance monitoring and analysis operations, using user input mechanisms 232 and 234. The user can also specify the frequency with which the operation will run, each day. This can be done using user input mechanism 236. Again, the user can provide identifying information using user input mechanism 238, and the user can set the schedule as previously configured, using user input mechanism 240.

At the appropriate time, PMAP system 180 performs the monitoring and analysis operation. This is indicated by block 242 in the flow diagram of FIG. 3. By way of example, where user 156 (in FIG. 1) wishes to have the operation run, the user can access a URL and download PMAP system 180 on the user's device 102. This is indicated by block 244 in the flow diagram of FIG. 3. The PMAP system 180 can assign a unique identifier each time it is loaded onto the user's device, and each time it is run by the user's device. This is indicated by block 246. The PMAP system 180 can be loaded and run in other ways as well, and this is indicated by block 248.

The various components in PMAP system 180 then begin collecting the macro-profile data for the user. Collecting the macro-profile data is indicated by block 250. For instance, they can identify the geographic location of the user (such as based on the user's IP address, or in other ways). This is indicated by block 252. Network profile collection component 186 can then collect ISP information 254, DNS provider information 256, routing information 258, and internal network information 260, among other network information. Telemetry collection component 182 illustratively collects the user's hardware profile 262, back end configuration information 264, packet loss information 266, page load times 268, and it can collect other information 270 as well.

Once all of the macro-profile data is collected, it is provided to data parsing/fitting component 190 where it is parsed. Based upon the particular scenario in which PMAP system 180 is invoked, the data can be processed in different ways. Where the system wishes to know an expected performance for the user, the data can be compared to other data to find similarly situated users (such as users in the same geographic location, with the same configuration and network information, etc.). That is, the collected data can be compared against sample data for other users to identify users having similar macro-profile information. UEX prediction component 184 can then provide output predictions indicative of a predicted performance for this user or for this geographic location, based on the actual performance data for the similarly situated users. Parsing the data and performing the predictive analysis is indicated by block 272 in FIG. 3.

Prediction component 184 can also compare the predicted performance to either performance thresholds or to the actual performance data for the given user. This is indicated by block 274. By way of example, if user 156 is already using service 110, and is experiencing perceived problems, then the predicted (or expected) performance of system 110 can be compared against the actual performance data. If the actual performance data is within a threshold level of the predicted performance data (given the performance data for other similarly situated users of system 110), then prediction component 184 may indicate that the user is experiencing a level of performance that is either expected, or within a threshold level of the expected performance, given the user's location and configuration information. On the other hand, if the user's actual performance is outside of the threshold level of the expected performance, then component 184 can indicate that the user is either experiencing better than expected performance, or worse than expected performance.

In another scenario where manufacturer personnel 172 are attempting to determine whether to launch the service in a given geographic area, then the predicted performance data for a user in that geographic area can be compared against threshold performance levels. If the expected performance meets the threshold performance levels, then this may influence manufacturer personnel 172 in deciding to launch in that geographic area. On the other hand, if the expected performance in that area does not meet the threshold performance levels, then personnel 172 may decide not to launch until the expected performance can be improved. This may happen, for example, by waiting for infrastructure improvements in that area (e.g., faster network service, better providers, etc.).

Outputting the results of the monitoring and predictive analysis is indicated by block 276 in FIG. 3. The results can take a wide variety of forms. For instance, they can be key performance indicators for the actual or predicted performance. This is indicated by block 278.

In another embodiment, the output results can show comparisons against threshold levels. This is indicated by block 280. They can include engineering comparisons 282 that can be used by support personnel (such as support engineers) or manufacturer personnel (such as manufacturing engineers) in order to identify problems that can be fixed by the manufacturer. Of course, the results can take other forms as well, and this is indicated by block 284.

When the results are ready for being output, recommendation engine 188 can also identify any recommendations that can be output in order to improve the performance. This is indicated by block 286 in FIG. 3. For instance, the recommendation engine 188 can output directions for the user or support personnel to take corrective action. This is indicated by block 288. The recommendation engine 188 can output other information as well, such as identifying where the trouble spots are without recommending corrective action. Outputting other information is indicated by block 290 in FIG. 3. If more runs are to be performed (e.g., if there are more scheduled runs) they are run. Otherwise, the results can be output not only to the user, or support personnel, but to a host of other systems as well. This is indicated by blocks 291 and 293 in FIG. 3.

FIG. 3B shows one exemplary user interface display 292 that shows not only the results of the performance monitoring and predictive analysis, but also recommendations. For instance, user interface display 292 includes column 294 that outputs the particular key performance indicators that were analyzed. Column 296 shows the results of comparison of the measured key performance indicators against threshold values and column 298 provides a corrective action that can be recommended to a given user, by recommendation engine 188.

Column 294 shows that the key performance indicators can include a wide variety of different things, such as the packet loss statistics, bandwidth information, ping results for a given service, DNS resolution time from the ping, the number of network hops to the service, the particular browser version and hardware version of the user, and general information. The comparison in column 296 can include a color identifier that identifies whether the comparison was favorable or unfavorable. For instance, if the comparison result is green, it indicates a favorable comparison of the actual data relative to a threshold level. If it is yellow, it indicates an intermediate comparison, and if it is red, it indicates an unacceptable comparison.

In FIG. 3B, column 298 only includes a corrective action if the comparison result in column 296 is either red or yellow. Of course, this is exemplary only. Also, all of the KPIs, comparison thresholds and corrective actions shown in FIG. 3B are exemplary only, and a wide variety of others can be used.

The results of the analysis runs can include a wide variety of other things as well. For example, they can include a measured or predicted page load time, an initial page load where no cache is used, a measured or actual page load time in subsequent loads on a browser which supports cache, and on a browser which does not support cache, extensible diagnostic service information, extensible real user monitoring pipeline information that is used to measure various performance criteria, among others.

FIG. 3C shows yet another embodiment of a user interface display 300 that can be generated to show a user the results of the monitoring and analysis operation. In the embodiment shown in FIG. 3C, user interface display 300 illustratively includes a run selector user input mechanism 302. Mechanism 302 allows the user to select which run the results will be displayed for. Previous run identifier portion 304 identifies the date and time of previous runs. In one embodiment, the items listed in portion 304 are links to the underlying information for those previous runs.

User interface display 300 also shows that a first set of columns 306 identify the KPI. Another column 308 identifies the results of the comparison against other data, and column 310 shows the recommendations. User interface display 300 includes a scroll mechanism 312 that allows the user to scroll through a wide variety of other performance information as well. Again, the information shown on user interface display 300 is exemplary only.

FIG. 3D shows yet another embodiment of a user interface display 314. Display 314 allows a support person (168 in FIG. 1) to search for the results of various performance monitoring and analysis runs performed for a variety of different clients. Thus, when a user (such as user 156) contacts a support person 168 for support, the support person can ask user 156 to schedule and run a performance monitoring and analysis operation (or a plurality of them). The support person 168 can then quickly and easily search for and pull up the results of that operation (or of a set of operations) run by user 156.

It can be seen in display 314 that the support person can insert search criteria in search criteria section 316. The search criteria can include the start and end dates when the operations were run, the country, the ISP, the machine identifier, or the unique run identifier. These are exemplary search criteria only.

The search results are illustratively provided in a results section 318. Each of the results in section 318 illustratively includes a download identifier corresponding to the PMAP system 180 that was downloaded for the user, a run identifier, a date, a country, an ISP identifier, and an indicator as to whether the results were complete. Each of the line items in section 318 illustratively has one or more user actuatable links that can be actuated by the support person in order to see the full results for the identified run.

FIGS. 3E-1 and 3E-2 (collectively FIG. 3E) show one example of a user interface display 320 that can be generated when the support person actuates one of the links in the search results section 318. It can be seen in display 320 that the display includes a customer display section 322 that displays the results, as they are seen by the particular customer (such as user 156). It also includes a support personnel section 324, that contains additional information that can be viewed by the support personnel 168 that is assisting the customer (or user 156). Section 324 includes a variety of additional information for the support personnel, including recommendations section 326 that hold recommendations or other information that can be conveyed from the support personnel 168 to the customer (or user 156). Again, the user interface displays generated for the support personnel and shown in these Figures are exemplary only.

It can thus be seen that the PMAP system 180 can be used to predict relatively accurate user experiences in terms of page load times for different scenarios. This can be based on round trip time between a cloud-based service and a DNS resolver. The page load times can be provided in terms of percentile end user experience from a location where the user is attempting to use the service. It can also be used to identify various issues that a customer is having with substantially any portion of their system, with the network service provider, the DNS provider, the internal networks, or other items where performance is suffering. It can also assist support personnel in helping the client troubleshoot issues. The tool can be scheduled to run once or many times to obtain additional information. It can also be used to assist in making decisions as to whether to launch a product in a new market, whether to sign up for a service (such as when a customer is deciding this) and in troubleshooting specific tenants of a multi-tenant system, among others.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

The present description has also discussed a cloud computing architecture. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

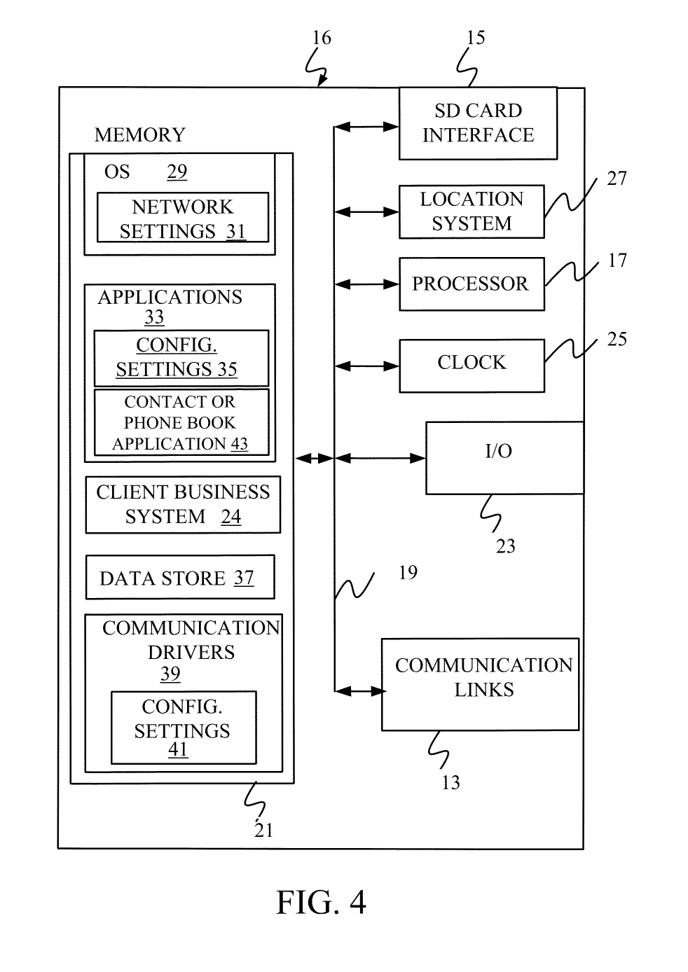

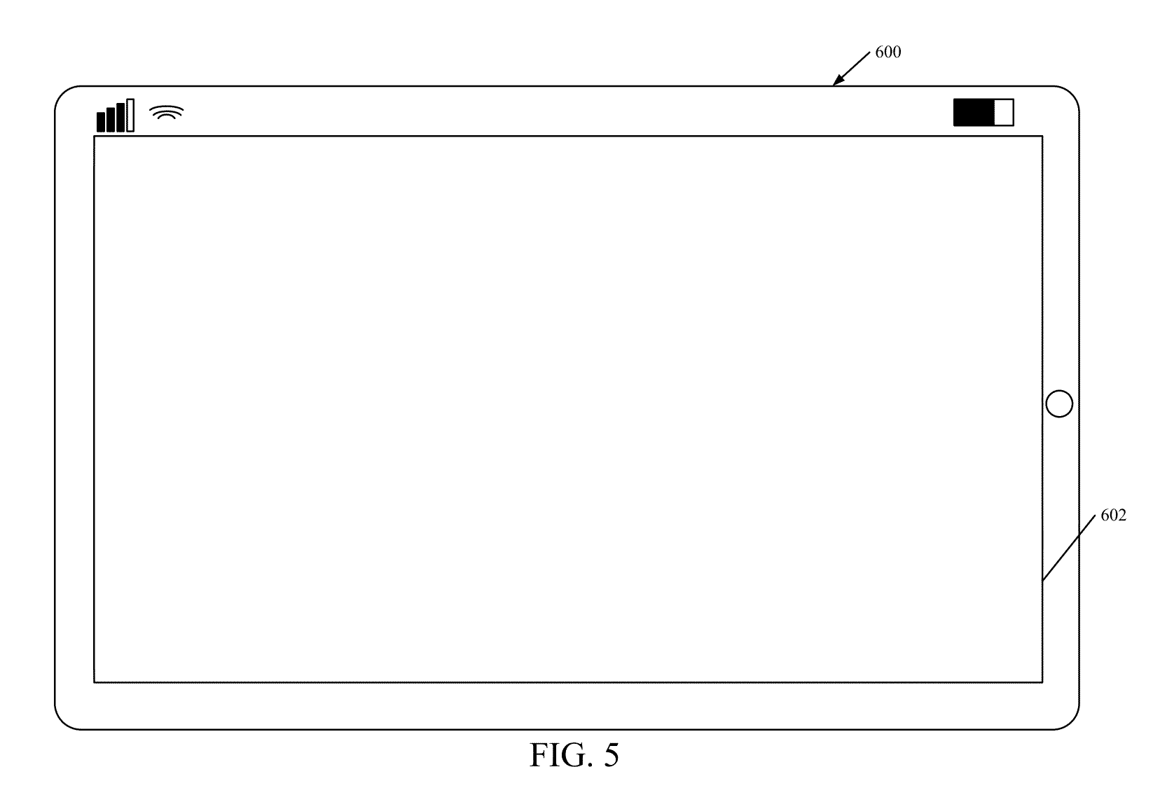

FIG. 4 is a simplified block diagram of one illustrative embodiment of a handheld or mobile computing device that can be used as a user's or client's hand held device 16, in which the present system (or parts of it) can be accessed or deployed. FIGS. 5-8 are examples of handheld or mobile devices.

FIG. 4 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems \are received on a removable Secure Digital (SD) card that is connected to a SD card interface 15. SD card interface 15 and communication links 13 communicate with a processor 17 (which can also embody processors 130-136 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 5 shows one embodiment in which device 16 is a tablet computer 600. In FIG. 5, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

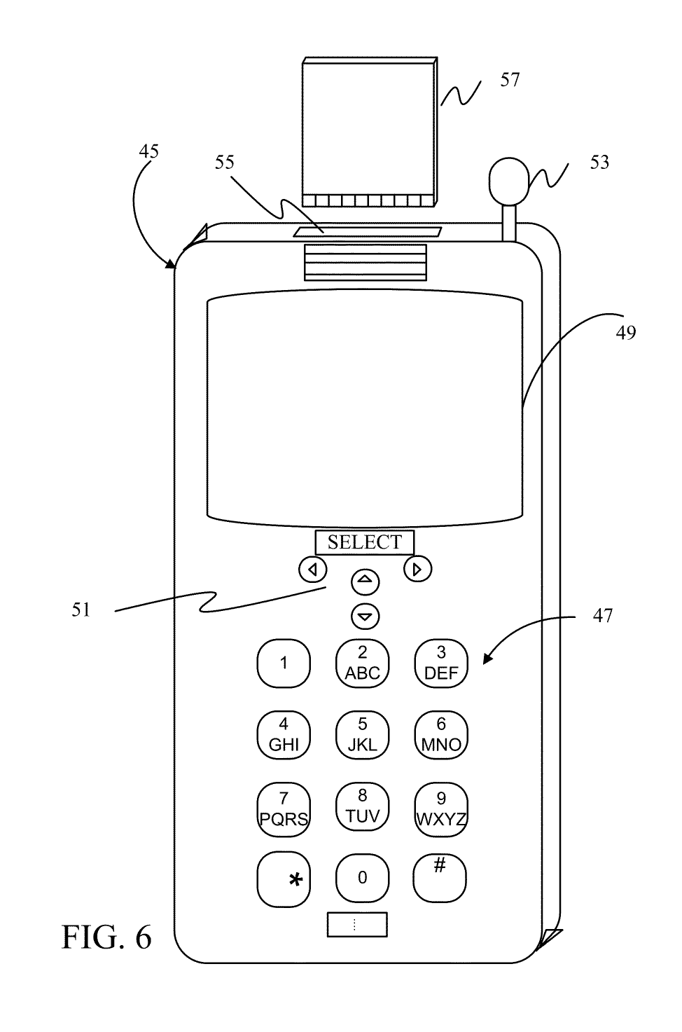

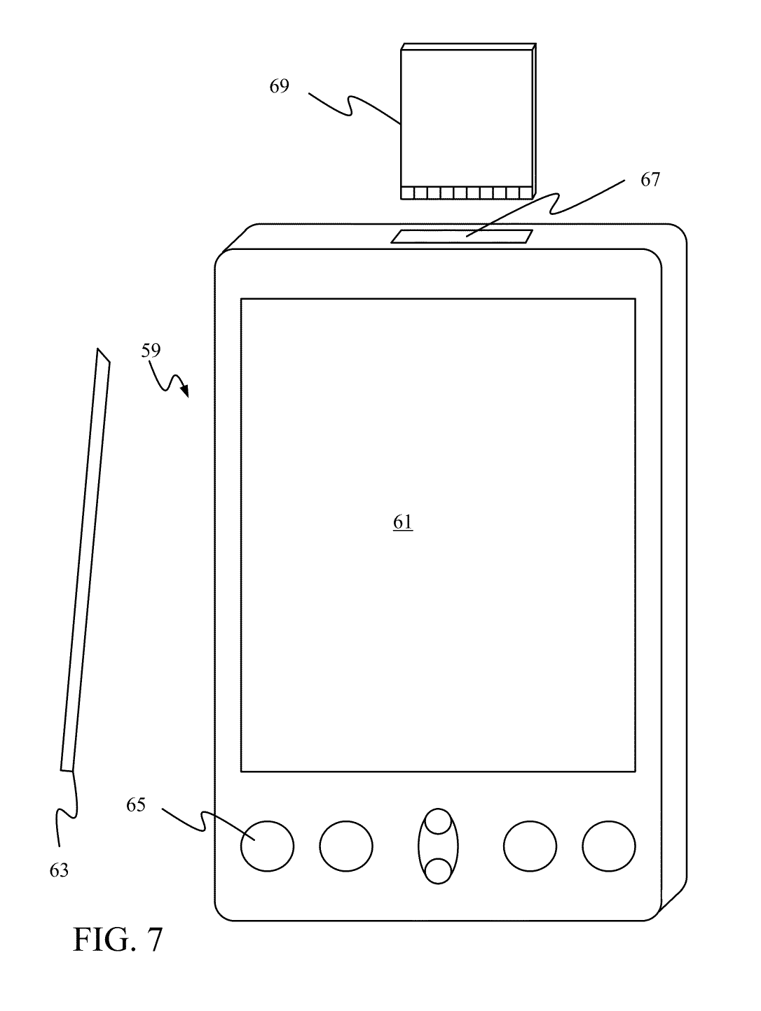

FIGS. 6 and 7 provide additional examples of devices 16 that can be used, although others can be used as well. In FIG. 6, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 7 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

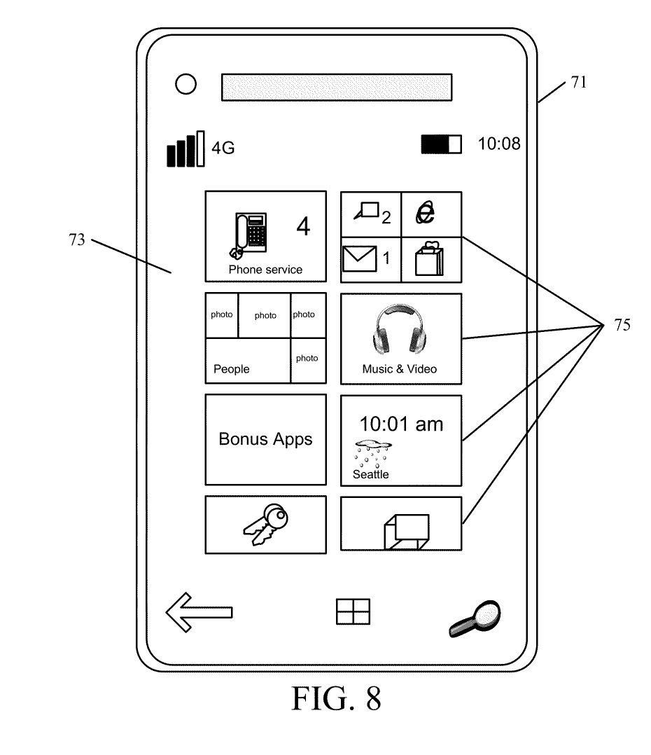

FIG. 8 is similar to FIG. 6 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

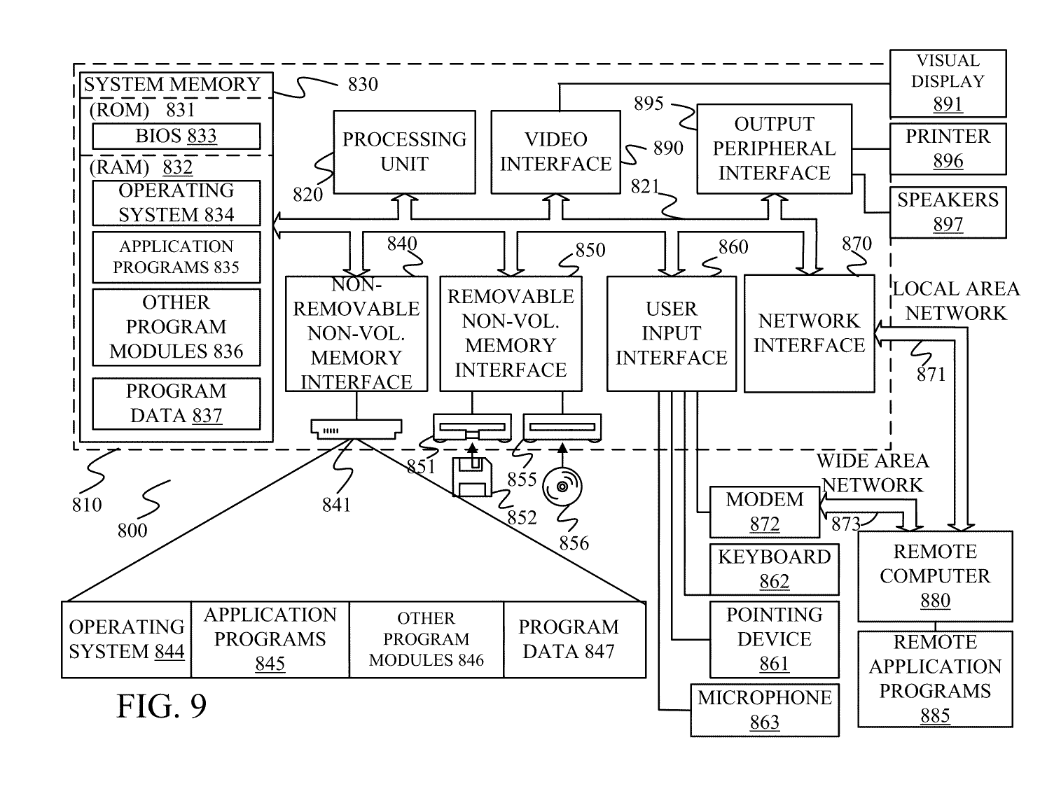

FIG. 9 is one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 130-136 or processors or servers in cloud 112 or on devices used by client support system 166 or manufacturer system 170), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
obtaining profile information corresponding to a user system;
performing a prediction analysis to obtain a predicted performance of a the user system, when accessing a computer system, based on the profile information; and
displaying a predicted performance indicator indicative of the predicted performance.

2. The computer-implemented method of claim 1 wherein performing the prediction analysis comprises:
obtaining a set of key performance indicators indicative of the predicted performance.

3. The computer-implemented method of claim 2 wherein obtaining the set of key performance indicators comprises:
obtaining a page load time indicator indicative of a predicted page load time for the user system, when accessing the computer system.

4. The computer-implemented method of claim 2 and further comprising:
obtaining an actual performance indicator indicative of actual performance of the user system when assessing the computer system.

5. The computer-implemented method of claim 4 and further comprising:
comparing the predicted performance indicator to the actual performance indicator to obtain a comparison value.

6. The computer-implemented method of claim 5 wherein outputting the predicted performance indicator comprises:
outputting the comparison value.

7. The computer-implemented method of claim 6 wherein outputting the comparison value comprises:
outputting an indication of whether the actual performance indicator is within a threshold value of the predicted performance indicator.

8. The computer-implemented method of claim 7 and further comprising:
if the actual performance indicator is not within the threshold value of the predicted performance indicator, outputting a suggested action to bring the actual performance indicator within the threshold value of the predicted performance indicator.

9. The computer-implemented method of claim 1 wherein performing a prediction analysis comprises:
comparing the profile information to performance information for other user systems to identify similar user systems; and
obtaining actual performance data for the similar user systems.

10. The computer-implemented method of claim 9 wherein performing the prediction analysis comprises:
performing the prediction analysis to obtain the predicted performance indicator based on the actual performance data for the similar user systems.

11. The computer-implemented method of claim 1 and further comprising:
receiving scheduling inputs to schedule obtaining the profile information and performing the prediction analysis.

12. The computer-implemented method of claim 1 wherein obtaining profile information comprises:
obtaining geographic information indicative of a geographic location of the user system.

13. The computer-implemented method of claim 1 wherein obtaining profile information comprises:
obtaining service provider information indicative of service providers for the user system.

14. The computer-implemented method of claim 1 wherein obtaining profile information comprises:
obtaining page load times for the user system.

15. The computer-implemented method of claim 1 wherein obtaining profile information comprises:
obtaining network and hardware configuration information for the user system.

16. A computer system, comprising:
a user system profile collection component that collects user system profile information;
a network profile collection component that collects network profile information for the user system;
a user experience prediction component that predicts an expected user system performance in accessing a computer system user system profile information and the network profile information;
a user interface component that outputs a predicted performance indicator indicative of the expected user system performance; and
a computer processor that is a functional part of the system and activated by the user system profile collection component, the network profile collection component, and the user experience prediction component to facilitate collecting the user system profile information and the network profile information and prediction of the expected user system performance.

17. The computer system of claim 16 wherein the user system profile information includes actual performance data indicative of an actual performance of the user system in accessing the computer system and wherein the user experience prediction component determines whether the actual performance is within an threshold value of the expected user system performance, and further comprising:
a recommendation engine that generates recommendations for improving the user system performance if the actual performance is outside the threshold value of the expected user system performance.

18. The computer system of claim 16 wherein the user experience prediction component identifies similar user systems with similar user system profile information and network profile information, and predicts the expected user system performance based on actual performance information for the similar user systems.

19. A computer readable storage medium that stores computer readable instructions which, when executed by a computer, cause the computer to perform a method, comprising:
obtaining profile information corresponding to a user system;
performing a prediction analysis to obtain a predicted performance indicator indicative of a predicted performance of the user system, when a computer system, based on the profile information, the predicted performance indicator including a page load time indicator indicative of a predicted page load time for the user system, when accessing the computer system; and
displaying the predicted performance indicator.

20. The computer readable storage medium of claim 19 wherein performing the prediction analysis comprises:
obtaining a set of key performance indicators indicative of the predicted performance.
